(19) United States
(12) Patent Application Publication
(10) Pub. No.: US 2026/0328232 A1
(43) Pub. Date: Oct. 22, 2026

(54) CONNECTOR ASSEMBLY AND ANCHORING METHOD

(71) Applicant: MULTIMATERIAL-WELDING AG, Biel (CH)

(72) Inventors: Mario LEHMANN, Les Pommerats (CH); Dylan HADE, Lugnorre (CH); Quentin RENEVEY, Sugiez (CH); Martin RHÊME, Belfaux (CH)

(21) Appl. No.: 19/157,528

(22) PCT Filed: Mar. 5, 2024
(86) PCT No.: PCT/EP2024/055684

§ 371 Date: Aug. 18, 2025

(30) Foreign Application Priority Data
Mar. 7, 2023 (CH) CH000245/2023

(51) Int. Cl. F16B 5/01; B29C 65/00; B29C 65/08; B29C 65/56

(52) U.S. Cl. CPC F16B 5/01; B29C 65/08; B29C 65/564; B29C 66/302; B29C 66/474; B29C 66/721; B29C 66/72525

(57) ABSTRACT

The present invention relates to a connector assembly (1) for being anchored in a lightweight building panel (30). The connector assembly (1) comprises a slider element (2) and a sleeve element (3) wherein the sleeve element (3) is configured to receive the slider element (2) therein. The sleeve element (3) comprises a circumferential wall (3.1) having a proximal flexible section (3.1.1) and an inner abutment portion (3.1.2), and the slider element (2) comprises a head portion (2.1) and a distal body portion (2.2). The head portion (2.1) of the slider element (2) is configured to radially expand the proximal flexible section (3.2) of the sleeve element (3) when the slider element (2) is driven into the sleeve element (3) during mounting. The distal body portion (2.2) of the slider element (2) and/or the inner abutment portion (3.1.2) of the circumferential wall (3.1) of the sleeve element (3) are configured to allow relative movement after overcoming a resistance therebetween during mounting and to secure the distal body portion (2.2) at the inner abutment portion (3.1.2), preferably by means of a shear joint (10) being formed at an interface therebetween. The inventions also relates to a respective anchoring method.

### TECHNICAL FIELD

The present invention generally relates to a connector assembly which is anchored in a lightweight building panel and to a respective anchoring method.

### BACKGROUND ART

A lightweight building panel or sandwich panel usually comprises a three-layer structure, with the two outside layers consisting of a thin, rigid material and the middle layer consisting of a thicker, lightweight material. The materials used may vary depending on the sandwich panel's purpose but ultimately this configuration should create a panel that becomes greater than the sum of its parts.

Sandwich panels can be useful in architecture because the outside layers provide durability and the inside layer keeps the panel lightweight, creating an easily customizable and adaptable panel.

Lightweight sandwich panels are versatile in their applications which include for example the retail industry for shelves and displays, the commercial industry for overhead or acoustic panels and oversized doors, the tradeshow industry for booths and displays, the recreational vehicles industry, especially for custom coaches, the healthcare industry including medical mobile units, the marine industry, including superyachts and luxury vessels, wall paneling, ceiling paneling, door paneling and tabletops. Other applications include aircraft interior, for example partition walls and cabin interior monuments, and tram or train floor panels.

In US 2011/0296788 A1 a method of anchoring a connector in a lightweight building element is described. The lightweight building element includes a first building layer and a second building layer arranged at a distance from the first building layer, the method comprising the steps of: providing a connector that comprises a sleeve element and a piston element, the piston element comprising a shaft portion and being movable in an axial direction relative to the sleeve element, while the sleeve element at least partially surrounds the shaft portion, wherein at least one of the sleeve element and of the piston element comprises a thermoplastic material; providing a through hole in the first building layer, the through hole comprising a circumferential wall; inserting the connector until a distal portion thereof rests against the second building layer, the second building layer arranged at a distance from the first building layer; coupling mechanical oscillations into the piston element while pressing the piston element towards the distal side, and thereby liquefying at least a portion of the thermoplastic material at an interface portion between the sleeve element and the piston element while the interface portion is adjacent the circumferential wall or distal with respect to it, thereby generating a liquefied thermoplastic material portion, and causing liquefied thermoplastic material of the liquefied thermoplastic material portion to flow radially outward and into structures of the first building layer and/or along an interior surface of the first building layer; and letting the liquefied thermoplastic material portion re-solidify to form a positive-fit connection with the first building layer, wherein at least one of the following conditions is fulfilled: the piston element reaches to a distal end of the connector, a distal end of the piston element resting against the second building layer after the step of inserting the connector is completed, and the distal end of the piston element comprises thermoplastic material portions which are at least partially liquefied by the step of coupling mechanical oscillations into the piston element while pressing; during a stage of the step of coupling mechanical oscillations into the piston element, the sleeve element is supported by the second building layer, and the piston element is supported by the sleeve element without direct contact with the second building layer.

While the above described solution may provide for a sufficiently strong anchorage of the connector in the lightweight building element, there is still a need for more efficient and better controlled ways of anchoring a connector in a lightweight building panel which ensure that an even more secure and reliable anchoring may be achieved without substantially affecting the lightweight material layer.

It is therefore the object of the present invention to provide for an improved connector and a respectively improved anchoring method by means of which the above shortcomings are overcome.

### DISCLOSURE OF INVENTION

According to a first aspect of the present invention these needs are settled by a connector assembly for being anchored in a lightweight building panel. The connector assembly comprises a slider element and a sleeve element wherein the sleeve element is configured to receive the slider element therein. The sleeve element comprises a circumferential wall having a proximal flexible section and an inner abutment portion and the slider element comprises a head portion and a distal body portion. The head portion of the slider element being configured to radially expand the proximal flexible section of the sleeve element when the slider element is driven into the sleeve element during mounting. In addition, the distal body portion of the slider element and/or the inner abutment portion of the circumferential wall of the sleeve element being configured to allow relative movement after overcoming a resistance therebetween during mounting and to secure the distal body portion at the inner abutment portion, preferably by means of a shear joint being formed at an interface therebetween.

The term “proximal flexible section” as used herein may comprise any sort of configuration which allows that the proximal section of the sleeve element to be radially expandable, i.e. in an outward direction substantially perpendicular to the longitudinal axis of the connector assembly, in order to get into (frictional respectively clamping) engagement with a distal surface of a first building layer of a lightweight building panel when the slider is driven into the sleeve element during the mounting process.

The formulation “configured to allow relative movement after overcoming a resistance” as used herein comprises particularly such interaction between a portion of the slider element and a portion of the sleeve element where the respective portion of the slider element and/or the respective portion of the sleeve element have, at least initially, non-conforming geometries wherein only under application of external vibrations and/or pressure the slider element may be further introduced into the sleeve element. This may in particular be achieved by providing liquefiable portions at the slider and/or sleeve element which form a shear joint connection when re-solidified after mounting. It is however also conceivable that for instance predetermined breaking points or sections with constrictions/widenings are provided at the slider and/or sleeve element which, after overcoming the respective resistance, result in frictional respectively clamping engagement therebetween.

The formulation “when the slider element is driven into the sleeve element” as used herein expressly includes embodiments where the proximal end face of the head portion of the slider element protrudes over the proximal end of the sleeve element respectively over the proximal flexible section of the sleeve element in order to provide a flush finish with the a first building layer of a lightweight building panel.

As used herein, the terms “proximal” and “distal” refer to directions and locations, namely “proximal” is the side from which an operator or machine (e.g. sonotrode) applies the mechanical vibrations and/or pressure, whereas distal is the opposite side.

Preferably, the head portion of the slider element comprises at its proximal end an outer diameter and the sleeve element comprises at its proximal end an inner diameter wherein the outer diameter of the proximal end of the head portion of the slider element is larger than the inner diameter of the proximal end of the sleeve element. In this manner the expansion of the proximal flexible section of the sleeve element can be achieved in an effective manner.

Preferably, the head portion of the slider element tapers in the distal direction from the outer diameter at its proximal end to an outer diameter of the body portion wherein the outer diameter of the distal body portion substantially corresponds to the inner diameter of the sleeve element at its proximal end. Preferably, the taper of the head portion of the slider element comprises a substantially conical section. This configuration has proven to provide for an evenly expansion of the proximal flexible section of the sleeve element.

Preferably, the proximal flexible section of the circumferential wall of the sleeve element comprises two or more longitudinal slots wherein between two neighboring longitudinal slots a wing is formed, respectively. Preferably, the longitudinal slots of the circumferential wall of the sleeve element comprise an arc-shape, respectively. Hereby, the flexibility characteristics may be provided in a particularly simple and reliable manner.

Preferably, the body portion of the slider element comprises at its distal outer circumference a plurality of notch-like indentations forming part of an abutment structure of the body portion of the slider element. Preferably, the plurality of notch-like indentations are evenly distributed about the distal outer circumference of the body portion of the slider element. Further preferably, the notch-like indentations comprise an arc-shape. The notch-like indentations may be used as spaces for at least partially receiving thermoplastic material liquefied during the mounting process. Further, the notch-like indentations are designed to provide for the appropriate resistance which has to be overcome in order to allow relative movement between the slider element and the sleeve element.

Preferably, between the notch-like indentations post-like elements are arranged which also form part of the abutment structure of the body portion of the slider element. The post-like elements provide the necessary initial stability.

Preferably, the post-like elements comprise longitudinal bulges at their outer wall. The longitudinal bulges are configured to prevent relative rotation between the slider element and the sleeve element.

Preferably, the abutment structure of the body portion of the slider element being adapted to at least partially liquefy under application of mechanical vibrations and/or pressure. Hereby, the preconditions for the later shear joint connection between the slider element and the sleeve element are provided.

Preferably, the inner abutment portion of the sleeve element comprises an inner circumferential protrusion defining an inner diameter being smaller than the outer diameter of the abutment structure of the body portion, particularly in the region of the post-like elements in an unliquefied state. In this context it is also noted that preferably in the medium and/or back wall regions of the notch-like indentations, the front face of the distal abutment structure of the distal body portion of the slider element is not in contact with the circumferential protrusion of the sleeve element. In this manner respectively by means of this design the optimal counter-load for the mounting process is achieved. In other words, the size of the non-contact area of the front face of the distal abutment structure with the upper face of the circumferential protrusion (i.e. in relation to the size of the contact area) may be used to adjust the resistance that has to be overcome to allow for relative movement between the slider element and the sleeve element.

Preferably, the inner abutment portion of the sleeve element being adapted to at least partially liquefy under application of mechanical vibrations and/or pressure. Also hereby, the preconditions for the later shear joint connection between the slider element and the sleeve element are provided.

Preferably, a variable diameter of the abutment structure of the body portion of the slider element in the region of the notch-like indentations is at least sectionally larger than the inner diameter defined by the inner abutment portion of the sleeve element. Hereby, it is ensured-i.e. as mentioned before by providing an appropriate adjustment of the resistance that has to be overcome to allow for relative movement between the slider element and the sleeve element-that the slider element fits through the inner abutment portion (i.e. when one or both components are at least partially liquefied) and is finally received in the sleeve element.

Preferably, the inner abutment portion is arranged in the longitudinal direction distally below the wings and longitudinal slots in the circumferential wall of the sleeve element. In this manner, the function of the proximal flexible section of the sleeve element is not impaired.

Preferably, the wings of the proximal flexible section of the sleeve element comprise at their inner walls longitudinal slits. These longitudinal slits are provided in order to prevent relative rotation between the slider element and the sleeve element. In particular, the longitudinal slits are be configured to engage with corresponding longitudinal bulges at the outer side wall of the post-like elements (e.g. for pre-assembly purposes).

Preferably, the distal abutment structure of the body portion of the slider element is adapted to form, after re-solidification, a shear joint at an interface with the inner abutment portion of the sleeve element. Preferably, the interface is formed between an inner front face of the circumferential protrusion of the sleeve element and an outer side wall portion of the liquefied abutment structure of the body portion of the slider element wherein the interface extends substantially parallel to the longitudinal axis of the connector assembly. This configuration has proven to provide for a very efficient and solid connection.

Preferably, the sleeve element comprises at its distal end an abutment structure being adapted to at least partially liquefy under application of mechanical vibrations and/or pressure. Preferably, the abutment structure at the distal end of the sleeve element comprises a tooth-shaped configuration. Further preferably, the tooth-shaped configuration includes teeth and gaps, wherein the circumferential length of the teeth is larger than the circumferential length of the gaps, preferably the circumferential length of the teeth is between about 1.5 times and about 2.5 times of the circumferential length of the gaps and more preferably about 2 times of the circumferential length of the gaps. Hereby, a solid connection may be achieved with a second building layer of the lightweight panel and also counter-load for the mounting process is provided, i.e. due to an increased contact surface with the proximal surface of the second outer building layer.

Preferably, the slider element comprises a central through opening. The through opening may be used for mounting standard components required for instance in the automotive or aviation industry. Preferably, in the region of the head portion the through opening comprises a funnel-shaped insertion section. This shape serves as insertion aid. Preferably, a sleeve-like metal insert is arranged in the through opening of the slider element. In this manner the stability may be increased for the mounting of the afore-mentioned components. Preferably, the sleeve-like metal insert comprises first and second coupling means corresponding to first and second coupling means of the inner wall of the slider element. The first and second coupling means may be in the form of corresponding circumferential recesses and circumferential protrusions (i.e. at the metal insert and/or the inner wall of the slider element), wherein the protrusions and recesses may take any appropriate shape and may be provided in any appropriate number. Hereby, a stable anchoring of the metal insert in the slider element is provided. It is however also possible that the sleeve-like metal insert is bonded to the inner wall of the slider element.

Preferably, the slider element is formed of a thermoplastic material wherein at least a portion of thermoplastic material is liquefiable. Also, the sleeve element is preferably formed of a thermoplastic material wherein at least a portion of the thermoplastic material is liquefiable. In this manner the necessary relative movement between the slider element and the sleeve during the mounting process is enabled (i.e. when mechanical vibrations and/or pressure are applied) and the necessary joint connections between the slider element and the sleeve element and between the sleeve element and the second building layer of the lightweight building panel.

According to a second aspect of the present invention there is provided a method of anchoring a connector assembly in a lightweight building panel wherein the connector assembly comprises a slider element and a sleeve element wherein the sleeve element being configured to receive the slider element and wherein the lightweight building panel comprises at least a first outer building layer and an interlining layer. The method comprises the following steps: providing the lightweight building panel with a pre-shaped hole for receiving the connector assembly; introducing the sleeve element of the connector assembly into the pre-shaped hole of the lightweight building panel and bringing a distal abutment structure of a body portion of the slider element in contact with an inner abutment portion of the sleeve element (this formulation expressly includes an embodiment where the slider element and the sleeve element are pre-assembled before the sleeve element is introduced into the pre-shaped hole), the distal abutment structure of the body portion of the slider element and/or the inner abutment portion of the sleeve element being adapted to liquefy under the application of mechanical vibrations and/or pressure; coupling mechanical vibrations into a proximal face of a head portion of the slider element and/or exerting pressure thereon so as to cause energy absorption between the distal abutment structure of the body portion of the slider element and the inner abutment portion of the sleeve element and to at least partially liquefy the distal abutment structure of the body portion of the slider element and/or the inner abutment portion of the sleeve element thereby generating a material flow therebetween; driving the slider element vertically downwards into the sleeve element thereby expanding a proximal flexible section of the circumferential wall of the sleeve element by means of the head portion of the slider element wherein the proximal flexible section of the sleeve element engages with a distal surface of the first outer building layer of the lightweight building panel; and the material flow enabling that the distal abutment structure of the body portion of the slider element overcomes (respectively fits through) and slides along the inner abutment portion of the sleeve element; and letting the material flow re-solidify whereby the distal abutment structure of the slider element is secured to the inner abutment portion of the sleeve element, preferably by forming a shear joint at an interface therebetween.

Preferably, the interface between the slider element and the sleeve element is substantially parallel to the longitudinal axis of the connector assembly. In this manner, a particularly strong shear joint may be formed between the slider element and the sleeve element.

Preferably, the sleeve element is introduced into the pre-shaped hole until a distal end of the sleeve element which comprises a tooth-shaped abutment structure is in contact with a proximal surface of a second outer building layer of the lightweight building panel. Preferably, the tooth-shaped abutment structure at the distal end of the sleeve element is at least partially liquefied thereby generating material flow between the tooth-shaped abutment structure and the proximal surface of a second outer building layer so as to provide an enlarged contact area of the distal end of the sleeve and the proximal surface of the second outer building layer. The enlarged contact area between the distal end of the sleeve and the proximal surface of the second outer building layer generates a counter load which supports the distal abutment structure of the body portion of the slider element getting past and sliding along the inner abutment portion of the sleeve element. Preferably, the material flow subsequently re-solidifies whereby the sleeve element is secured to the second outer building layer of the lightweight building panel, preferably means of a tee joint being formed at a substantially horizontal interface therebetween.

Preferably, the head portion of the slider element comprises at its proximal end an outer diameter and the sleeve element comprises at its proximal flexible section an inner diameter wherein the outer diameter of the proximal end of the head portion of the slider element is larger than the inner diameter of the proximal flexible section of the sleeve element so as to expand during mounting the inner diameter of the proximal flexible section sleeve element to an inner diameter being substantially as large as the inner diameter of the pre-shaped hole in the first outer building layer. This configuration has proven to provide for an evenly and efficient expansion functionality.

Preferably, the distal abutment structure of a body portion of the slider element comprises a plurality of notch-like indentations configured to provide for a pre-defined counter-load (resistance) before partially liquefying and the the slider element being driven vertically downwards into the sleeve element. Preferably, between the notch-like indentations post-like elements are formed comprising longitudinal bulges at their outer side wall being configured to prevent relative rotation between the slider element and the sleeve element. Further preferably, the proximal flexible portion of the circumferential wall of the sleeve element comprises wings having longitudinal slits in their inner wall configured to prevent relative rotation between the slider element and the sleeve element. In particular, the longitudinal slits are configured to engage with the corresponding longitudinal bulges at the outer side wall of the post-like elements (e.g. for pre-assembly purposes). Preferably, the first outer building layer and the second outer building layer each comprises a building layer material and are thinner and more dense than the interlining layer of the lightweight building panel.

Preferably, the first outer building layer (and if applicable optionally both, the first and second outer building layers) comprises a fiber reinforcement, i.e., is of a fiber composite material. Especially, the first outer building layer (or both outer building layers) may comprise glass fiber reinforcement and/or a carbon fiber reinforcement and/or a natural fiber reinforcement (flax, hemp, etc.). The manufacturing process may comprise a deep drawing/embossing step-that includes re-orienting the fibers. To this end, the fiber material used may optionally have a structure especially suitable for draping. Such textile structures may for example include woven fabrics (especially elastic wovens, such as 1-4 wovens or even 1-8 wovens), knits, etc.

The interlining layer may for example comprise a macroscopic, dedicated structure with a large portion of hollow spaces, whereby the density of the interlining layer is comparably small. For example, the interlining layer may comprise vertically extending walls (walls extending parallel to the axis) between the first and second outer building layers. In embodiments, such walls form a honeycomb structure. Examples such structures include cardboard or aramid structures, for example cardboard or aramid honeycomb structures, with or without impregnation. There also exist lightweight building elements that are suitable as first objects for the present invention and that have an interlining layer comprising a structure of thermoplastic walls, such as a thermoplastic, for example polypropylene-honeycomb structure. In addition or as an alternative, the interlining layer may comprise a porous material, such as a polymer foam. The interlining layer may in addition to the dedicated structures and/or porous material also an adhesive, for example a foaming adhesive, such as a PU adhesive, at the interface to the building layer(s) and the interlining.

Further preferably, the slider element and the sleeve element are formed of a thermoplastic material wherein a portion of the thermoplastic material is liquefiable.

In this text the expression “liquefiable thermoplastic material” or “liquefiable material” or “thermoplastic” is used for describing a material comprising at least one thermoplastic component, which material becomes liquid (flowable) when heated, in particular when heated through friction i.e. when arranged at one of a pair of surfaces being in contact with each other and vibrationally moved relative to each other. In some situations, for example if the connector has to carry substantial loads, it may be advantageous if the material has an elasticity coefficient of more than 0.5 GPa. In other embodiments, the elasticity coefficient may be below this value. Thermoplastic materials are well-known in the automotive and aviation industry. For the purpose of the method according to the present invention, especially thermoplastic materials known for applications in these industries may be used. A thermoplastic material suitable for the method according to the invention is solid at room temperature (or at a temperature at which the method is carried out). It preferably comprises a polymeric phase (especially C, P, S or Si chain based) that transforms from solid into liquid or flowable above a critical temperature range, for example by melting, and re-transforms into a solid material when again cooled below the critical temperature range, for example by crystallization, whereby the viscosity of the solid phase is several orders of magnitude (at least three orders of magnitude) higher than of the liquid phase. The thermoplastic material will generally comprise a polymeric component that is not cross-linked covalently or cross-linked in a manner that the cross-linking bonds open reversibly upon heating to or above a melting temperature range. The polymer material may further comprise a filler, e.g. fibres or particles of material which has no thermoplastic properties or has thermoplastic properties including a melting temperature range which is considerably higher than the melting temperature range of the basic polymer. In this text, generally a “non-liquefiable” material is a material that does not liquefy at temperatures reached during the process, thus especially at temperatures at which the thermoplastic material of the connector is liquefied. This does not exclude the possibility that the non-liquefiable material would be capable of liquefying at temperatures that are not reached during the process, generally far (for example by at least 80 °C) above a liquefaction temperature of the thermoplastic material or thermoplastic materials liquefied during the process. The liquefaction temperature is the melting temperature for crystalline polymers. For amorphous thermoplastics the liquefaction temperature (also called “melting temperature in this text”) is a temperature above the glass transition temperature at which the becomes sufficiently flowable, sometimes referred to as the ‘flow temperature’ (sometimes defined as the lowest temperature at which extrusion is possible), for example the temperature at which the viscosity drops to below 10⁴ Pa*s (in embodiments, especially with polymers substantially without fiber reinforcement, to below 10³ Pa*s), of the thermoplastic material. For example, a non-liquefiable material may be a metal, such as aluminum or steel, or wood, or a hard plastic, for example a reinforced or not reinforced thermosetting polymer or a reinforced or not reinforced thermoplastic with a melting temperature (and/or glass transition temperature) considerably higher than the melting temperature/glass transition temperature of the liquefiable part, for example with a melting temperature and/or glass transition temperature higher by at least 50 °C or 80 °C or 100 °C.

Specific embodiments of thermoplastic materials as used herein include Polyetherketone (PEEK), polyesters, such as polybutylene terephthalate (PBT) or Polyethylenterephthalat (PET), Polyetherimide, Polyphenylene sulfide, a polysulfone (PSU, PES, etc.) a polyamide, for example Polyamide 12, Polyamide 11, Polyamide 6, or Polyamide 66, Polymethylmethacrylate (PMMA), Poly oxy methylene, or polycarbonateurethane, a polycarbonate or a polyester carbonate, or also an acrylonitrile butadiene styrene (ABS), an Acrylester-Styrol-Acrylnitril (ASA), Styrene-acrylonitrile, polyvinyl chloride, polyethylene, polypropylene, and polystyrene, or copolymers or mixtures of these.

In addition to the thermoplastic polymer, the thermoplastic material may also comprise a suitable filler, for example reinforcing fibers, such as glass and/or carbon fibers. The fibers may be short fibers. Long fibers or continuous fibers may be used especially for portions of the first and/or of the second object that are not liquefied during the process. The fiber material (if any) may be any material known for fiber reinforcement, especially carbon, glass, Kevlar, ceramic, e.g. mullite, silicon carbide or silicon nitride, high-strength polyethylene (Dyneema), etc. Other fillers, not having the shapes of fibers, are also possible, for example powder particles.

Mechanical vibration or oscillation suitable for embodiments of the method according to the invention has preferably a frequency between 2 and 200 kHz (even more preferably between 10 and 100 kHz, or between 20 and 40 kHz) and a vibration energy of 0.2 to 20 W per square millimeter of active surface. The vibrating tool (e.g. sonotrode) is e.g. designed such that its coupling-in face oscillates predominantly in the direction of the tool axis (longitudinal vibration) and with a peak-to-peak amplitude of between 1 and 100 μm, preferably around 60 to 90 μm. Such preferred vibrations are e.g. produced by ultrasonic devices as e.g. known from ultrasonic welding.

### BRIEF DESCRIPTION OF THE DRAWINGS

The connector and anchoring method according to the present invention are described in more detail herein below by way of exemplary embodiments and with reference to the attached drawings, in which:

FIG. 1 shows an exploded view of an inventive connector assembly;

FIG. 2 shows a perspective view of a slider element of an inventive connector assembly;

FIG. 3 shows a perspective view of a sleeve element of an inventive connector assembly;

FIG. 4 shows a perspective view of an inventive connector assembly in a pre-assembly state;

FIG. 5 shows a sectional view of the slider element of the inventive connector assembly;

FIG. 6 shows a sectional view of the sleeve element of the inventive connector assembly;

FIG. 7 shows a sectional view of the inventive connector assembly in the pre-assembly state;

FIG. 8 shows a schematic illustration of the inventive connector assembly connected together (outside a lightweight building panel);

FIG. 9 shows a schematic sectional view of an inventive connector assembly when fully anchored in a lightweight building panel;

FIG. 10 shows a sectional view of a preferred embodiment of the inventive connector assembly with elongated slider element and elongated sleeve element; and

FIG. 11 shows a sectional view of a preferred embodiment of a slider element of an inventive connector assembly.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

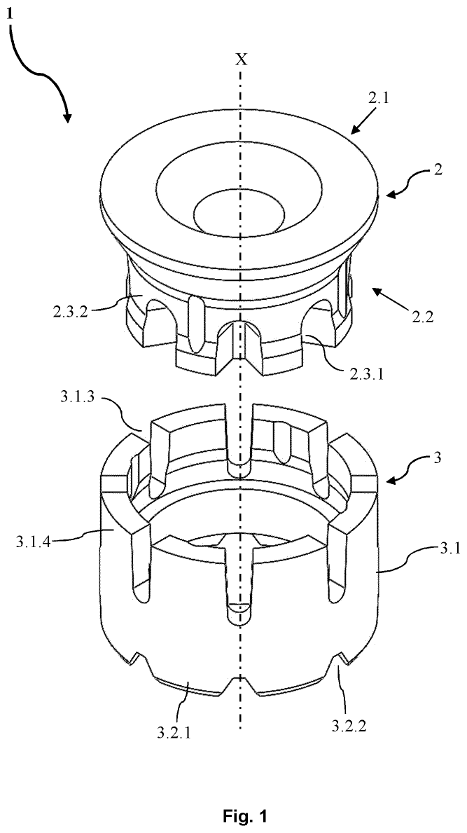

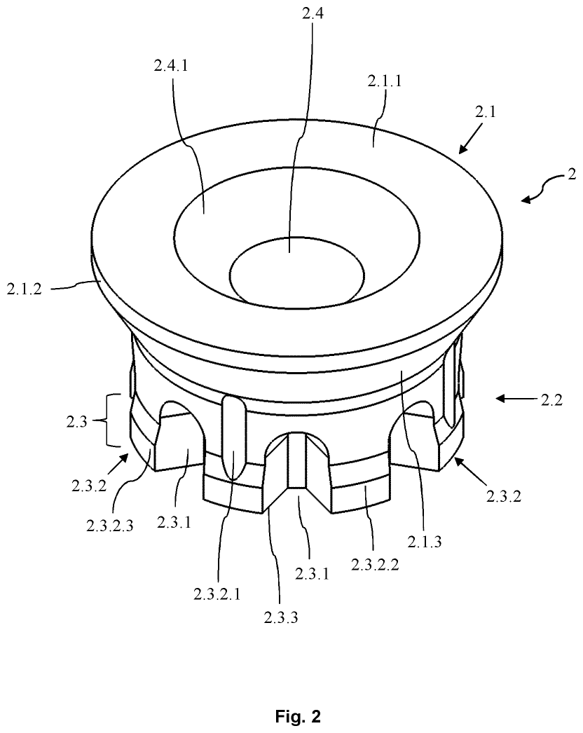

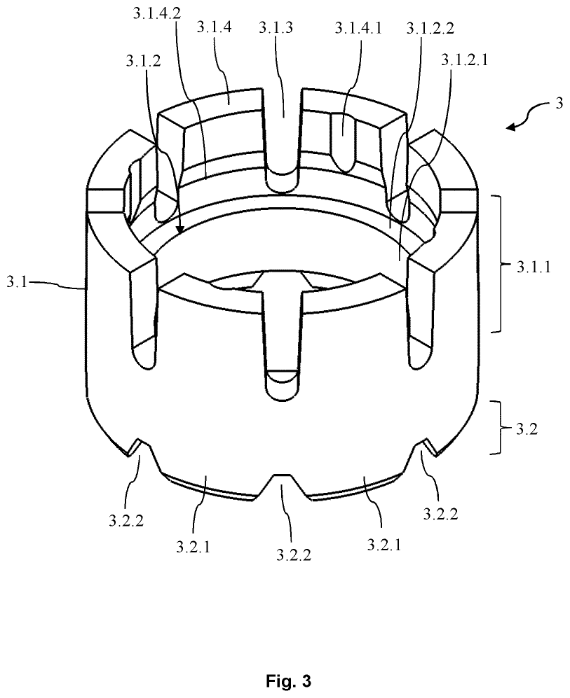

In FIG. 1 shows an exploded view of the inventive connector assembly 1 with the slider element 2 and the sleeve element 3 pulled apart along longitudinal axis X and FIGS. 2 and 3 show the slider element 2 respectively the sleeve element 3 individually.

As can be seen, the slider element 2 comprises a head portion 2.1 having a proximal face 2.1.1 from which a circumferential rim 2.1.2 extends perpendicularly in the distal direction. The rim 2.1.2 at the proximal end of the head portion 2.1 is followed by conical or tapering section 2.1.3 which transversely extends in the distal direction until the distal body portion 2.2 which extends substantially perpendicular in the distal direction.

At the distal end of the distal body portion 2.2 there are formed, in an alternating manner, post-like elements 2.3.2 and notch-like indentations 2.3.1 in the outer wall which represent the distal abutment structure 2.3 of the distal body portion 2.2 with bottom face 2.3.3. The notch-like indentations 2.3.1 form an arc in the outer wall of the distal body portion 2.2 and the space defined by the notch-like indentations 2.3.1 gets narrower in the in the radial direction (i.e. perpendicular to the longitudinal axis X). At least some of the post-like elements 2.3.2 comprise longitudinal bulges 2.3.2.1 formed therein. Further, the lower portions of the post-like elements 2.3.2 comprise slight radial expansions 2.3.2.2 having a slightly larger outer diameter than at the proximal end of the body portion 2.2, i.e. at the transition to the conical section 2.1.3 of the head portion 2.1. Further, the slider element 2 comprises a centrally arranged through opening 2.4 with a funnel-shaped insertion section 2.4.1.

The sleeve element 3 comprises a circumferential wall 3.1 which comprises a proximal flexible section 3.1.1 which consists of alternatingly arranged longitudinal slots 3.1.3 and wings 3.1.4 formed between two neighbouring longitudinal slots 3.1.3, respectively. In the inner wall of the wings 3.1.4 of the proximal flexible section 3.1.1 longitudinal slits 3.1.4.1 and a slight radial recess 3.1.4.2 are arranged wherein the radial recess 3.1.4.2 is arranged below the longitudinal slits 3.1.4.1. The radial recess 3.1.4.2 is designed to correspond to the radial expansions 2.3.2.2 of the post-like elements 2.3.2 of the distal body portion 2.2 of the slider element 2. Further, just below the bottom of the arc-shaped longitudinal slots 3.1.3, there is provided at the inner wall of the sleeve element 3 an inner abutment portion 3.1.2 in the form of an inner circumferential protrusion with a front face 3.1.2.1 and an upper face 3.1.2.2 which forms a step feature at which the bottom face 2.3.3 of the distal body portion 2.2 of the slider element 2 abuts in an initial state, as will be described further below.

At its distal end, the sleeve element 3 comprises an abutment structure 3.2 with tooth-shaped configuration. The tooth-shaped configuration consists of alternatingly arranged teeth 3.2.1 and gaps 3.2.2, the function which will be described further below. The circumferential length of the teeth 3.2.1 is larger than the circumferential length of the gaps 3.2.2, preferably the circumferential length of the teeth 3.2.1 is between about 1.5 times and about 2.5 times of the circumferential length of the gaps 3.2.2 and more preferably about 2 times of the circumferential length of the gaps 3.2.2. The inner circumferential protrusion 3.1.2 of the sleeve element 3 ends above the teeth 3.2.1 and gaps 3.2.2 of the abutment structure 3.2.

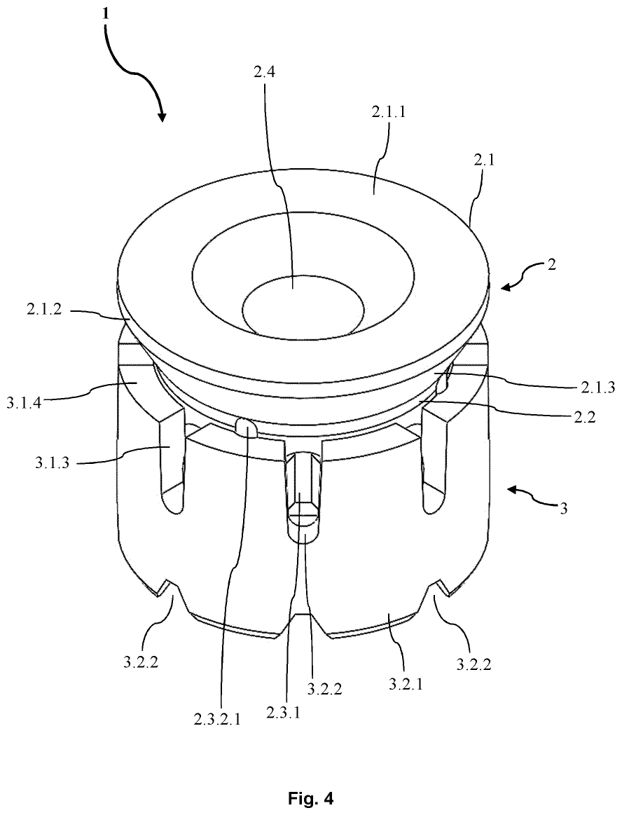

In FIG. 4, the slider element 2 has been inserted into the sleeve element 3 until the distal body portion 2.2 of the slider element 2 abuts with its distal abutment structure at the inner abutment portion 3.1.2 of the sleeve element 3. In this position, the conical section 2.1.3 of the head portion 2.1 is not yet in contact with the wings 3.1.4 of the proximal flexible section 3.1.1 of the sleeve element 3. The proximal end of the longitudinal bulges 2.3.2.1 protrudes over the upper edge of the wings 3.1.4 of the sleeve element 3. In this position, the longitudinal bulges 2.3.2.1 engage into the longitudinal slits 3.1.4.1 in the inner wall of the wings 3.1.4 of the proximal flexible section 3.1.1 (above the teeth 3.2.1) and thus prevent relative rotation between the slider element 2 and the sleeve element 3. The notch-like indentations 2.3.1 of the distal body portion 2.2 of the slider element 2 may be partially seen through the longitudinal slots 3.1.3 of the sleeve element 3.

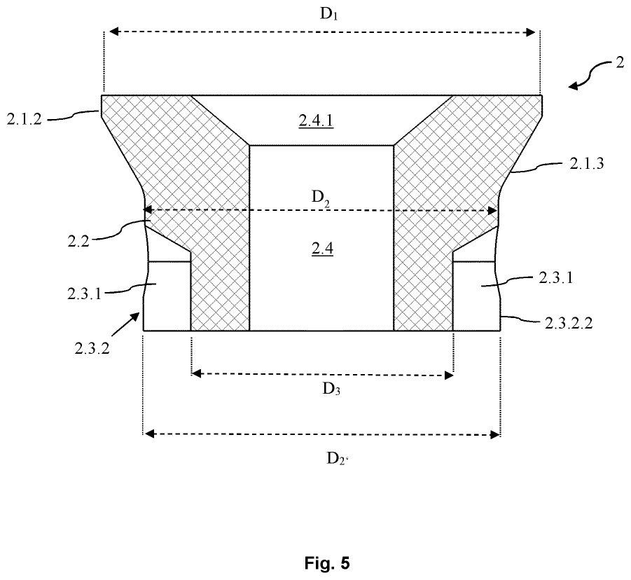

In FIG. 5, a cross-section through the slider element 2 is depicted with diameters of the different sections of the slider element 2. The region of the rim 2.1.2 respectively the proximal face the head portion 2 comprises the largest outer diameter D₁. From the rim 2.1.2 the head portion tapers in the conical section 2.1.3 to a proximal diameter D₂ of the distal body portion 2.2. This diameter is slightly smaller than diameter D2′ at the distal end of the distal body portion 2.2, i.e. in the region of the radial expansions 2.3.2.2 of the post-like elements 2.3.2. The diameter D₃ formed between the back walls of the notch-like indentations 2.3.1 is smaller than the diameters D₂ and D₂ but larger than the diameter D₄ of the through hole 2.4.

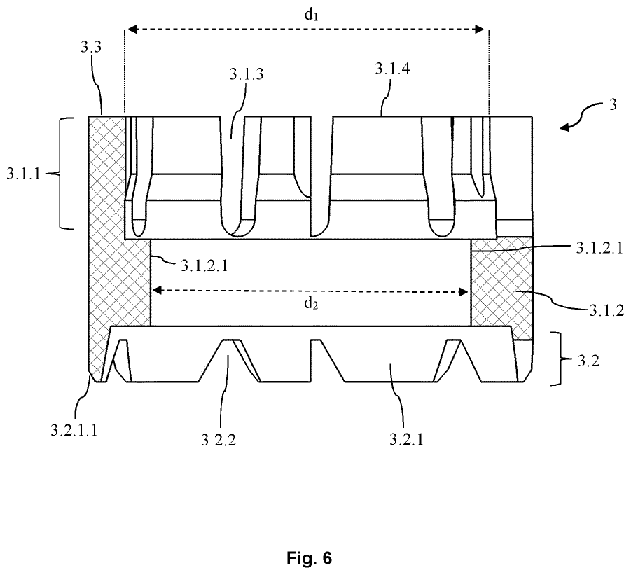

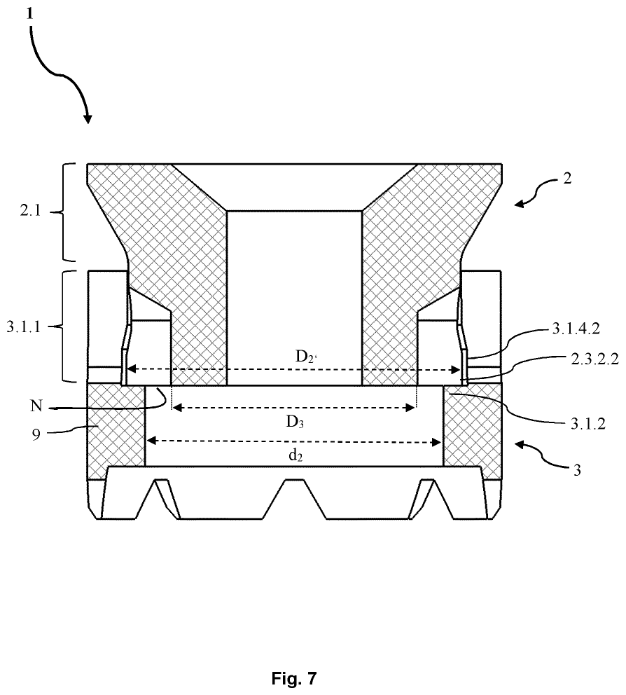

In FIG. 6, a cross-section through the sleeve element 2 is illustrated with diameters of the different sections of the sleeve element 3. The upper region of the proximal flexible section 3.1.1 comprises the largest inner diameter d₁. In a lower region of the proximal flexible section 3.1.1, i.e. at the radial recess 3.1.4.2 the diameter d_{1′} is slightly larger in order to provide for a secure holding of an inserted slider element 2, as is described further below in connection with FIG. 7. The inner diameter d₂ of the inner circumferential protrusion respectively the abutment portion 3.1.2 of the sleeve element 3 is slightly smaller than inner diameter di and inner diameter d_{1′} of the proximal flexible section 3.1.1. In other words, the abutment portion is formed as step feature with a front face 3.1.2.1 and an upper face 3.1.2.2. As one can also see, the teeth 3.2.1 of the tooth-shaped abutment structure at the distal end of the sleeve element 3 comprise a bevel 3.2.1.1 which may serve as an energy concentrator. The proximal face 3.3 of the sleeve element 3 is usually flat.

In FIG. 7 there is shown a cross-sectional view of an inventive connector assembly when the slider element 2 is just inserted into the sleeve element 3. The head portion 2.1 of the slider element protrudes from the upper end of the proximal flexible section 3.1.1 of the sleeve element 3 wherein the upper end of the distal body portion 2.2 of the slider element 2 abuts the inner wall of the proximal circumferential section 3.1.1 without expanding the latter. The radial expansions 2.3.2.2 of the post-like elements of the slider element 2 abut with their bottom face at the inner circumferential protrusion 3.1.2 of sleeve element 3 and are laterally received in the radial recess 3.1.4.2 of the lower portion of the proximal flexible section 3.1.1 of the sleeve element such that a secure holding of the slider element 2 is ensured in this pre-mounting position. It is understood that in the regions of the notch-like indentations the distal body portion of the slider element 2 does not or only partially abut at the inner circumferential protrusion 3.1.2 of the sleeve element 3. Hence, these regions may also serve as energy concentrators. The diameter D₃ formed between the back walls of the notch-like indentations 2.3.1 is smaller than the inner diameter d₂ of the inner circumferential protrusion 3.1.2 whereas the outer diameter D₂ of the distal body portion is larger than the inner diameter d₂ of the inner circumferential protrusion 3.1.2. The variable diameter D_{2′} of the distal body portion in the region of the notch-like indentations 2.3.1 is at least sectionally larger (i.e. particularly in the region of the radial expansions 2.3.2.2) than the inner diameter d₂ defined by the inner abutment portion/the inner circumferential protrusion of the sleeve element 3 (in the medium and back wall region of the notch-like indentations variable diameter D_{2′} is is yet smaller than inner diameter d₂ such that a non-contact area N results). The size of the non-contact area N between the upper face of the inner circumferential protrusion and the front face of the distal body portion of the slider element (i.e. in relation to the size of the respective contact area) is used to adjust the resistance that has to be overcome to allow for relative movement between the slider element and the sleeve element, as described generally above.

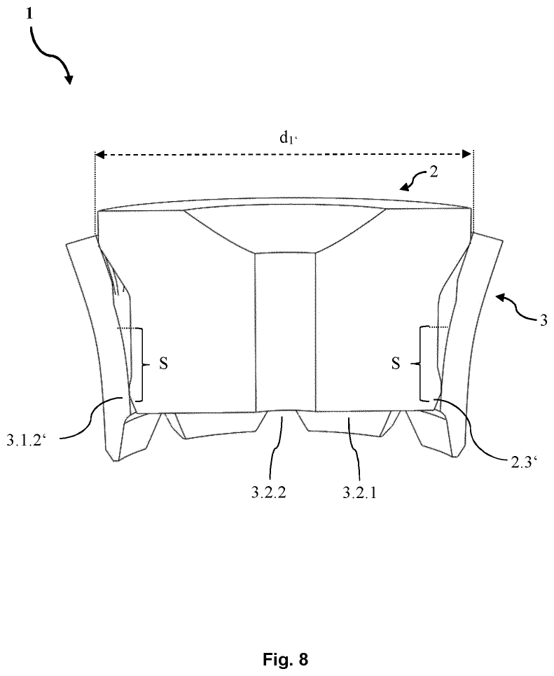

FIG. 8 depicts schematically an inventive connector assembly 1 with the slider element 2 and the sleeve in a connected state outside of a lightweight building panel 10 with the teeth 3.2.1 of the tooth-shaped abutment structure at the distal end of the sleeve element being still intact. The head portion of the slider element 2 in the region of its rim expands the proximal circumferential section of the sleeve element to a diameter d_{1′} wherein the rim of the head portion still protrudes, at least partially, over upper end of the proximal flexible section of the sleeve element 3. In the regions of the interface S between the inner side wall of the sleeve and the outer side wall of the distal body portion of the slider element 2 a shear joint (not shown) is formed by means of liquefied material portions of the circumferential protrusion of the sleeve element 3 and/or the abutment structure (i.e. formed by the notch-like indentations and the post-like elements) of the distal body portion of the slider element 2. In other words, in this state the inner circumferential protrusion 3.1.2 of the sleeve element 3 and the distal abutment structure 2.3 of the slider element 2 have been at least partially liquefied such that they have been labelled 3.1.2′ and 2.3′ in this drawing.

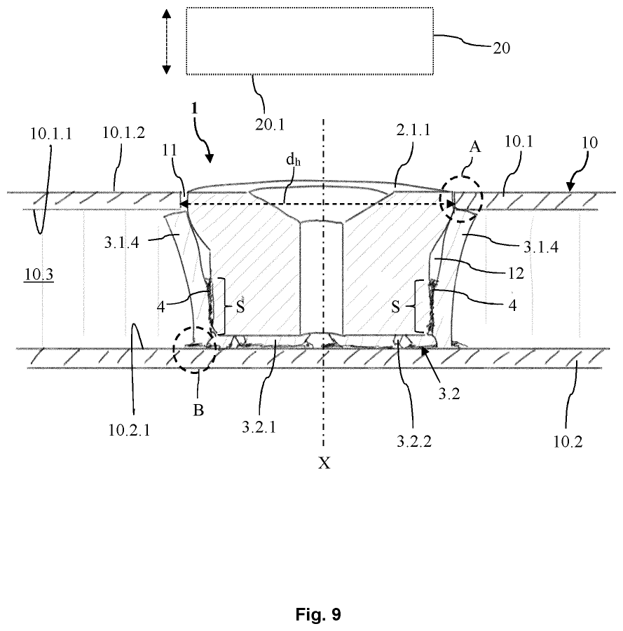

A schematic sectional view of an inventive connector assembly 1 when fully anchored in a lightweight building panel 10 is depicted in FIG. 9. As one can see, the sonotrode 20 with its coupling-in face 20.1 has been lifted off the proximal face 2.1.1 of the head portion of the slider element 2 into which the vibrations generated by the sonotrode 20 are coupled and to which pressure is applied by the latter. The proximal face 2.1.1 is substantially flush with a proximal surface 10.1.2 of the first outer building layer 10.1 of the lightweight building panel 10. The conical section and the rim of the head portion 2.1 of the slider element 2 have expanded the wings 3.1.4 of the proximal flexible section of the sleeve element 3 such that they engage in a clamping respectively frictional manner with a distal surface 10.1.1 of the first outer building layer 10.1, i.e. such that the inner diameter of the proximal flexible section substantially corresponds to the inner diameter dn of a pre-shaped hole 11 in the region of the first outer building layer 10.1. Thereby the material of an interlining layer 10.3 being arranged between the first outer building layer 10.1 and a second outer building layer 10.2 of the lightweight building panel 10 is radially compressed to a certain extent.

Further, in the region of the interface S in the distal region between slider element and the sleeve element re-solidified thermoplastic material of the distal abutment structure of the slider element of the inner circumferential protrusion of the sleeve element forms a substantially vertical shear joint 4. The re-solidified thermoplastic material does usually not fill the complete hollow space 12 between the sleeve element and the slider element and does in particular not penetrate outwardly into the interlining layer 10.3 of the lightweight building panel 10 at anchoring location A.

At the distal end of the sleeve element, the teeth 3.2.1 of the tooth-shaped abutment structure 3.2 have at least partially been liquefied and the re-solidified thermoplastic material forms a tee joint connection 13 (or multiple tee joint connections) with the proximal surface 10.2.1 of the second outer building layer 10.2. Portions of the gaps 3.2.2 of the tooth-shaped abutment structure 3.2 may remain free of thermoplastic material.

Hence, altogether three anchoring locations are formed, namely anchoring location A between distal surface 10.1.1 of the first outer building layer 10.1 and the wings 3.1.4 of the sleeve element (clamping respectively frictional engagement), anchoring location respectively interface S between the slider element and the sleeve element (vertical shear joint) and anchoring location B between the tooth-shaped abutment structure 3.2 of the sleeve element and the proximal surface 10.2.1 of the second outer building layer 10.2 (horizontal tee joint(s)). Yet, it is generally conceivable to provide only anchoring locations A and S in order to achieve an improved anchoring.

A preferred embodiment of the inventive mounting process of an inventive connector assembly 1 in the lightweight building panel 10 from an initial state to the mounted respectively fully anchored state, as shown in FIG. 9, is exemplarily described in the following (referring back also to the previous figures for the reference numbers).

In the initial state, the sleeve element 3 is sitting in the pre-shaped hole 11 previously formed in the first outer building layer 10.1 and the interlining layer 10.3 of the lightweight building panel 10. The teeth 3.2.1 of the distal abutment structure 3.2 are in contact with the proximal surface 10.2.1 of the second outer building layer 10.2 of the lightweight building panel 10. The distal body portion 2.2 of the slide is sitting in the sleeve element 3 wherein the bottom face 2.3.3 of the distal abutment structure 2.3 of the slider element 2 is in contact with the upper face 3.1.2.2 of the inner circumferential protrusion 3.1.2 of the sleeve element 3. The conical section 2.1.3 of the slider element 2 is sitting outside (above) the proximal face 3.3 of the sleeve and the first outer building layer 10.1 of the lightweight building panel 10. Then, a sonotrode 20 is pressed with its coupling-in face 20.1 against the proximal face 2.1.1 of the head portion 2.1 of the slider element 2 with a preset force and ultrasonic respectively mechanical vibrations are coupled into proximal face 2.1.1.

Subsequently, the vibrations are transferred through the proximal face of the slider element 2, through the head and distal body portion of the slider element 2 and up to the bottom face 2.3.3 which abuts at the upper face 3.1.2.2 of the inner circumferential protrusion 3.1.2 of the sleeve element 3. The vibrations are further transferred to the inner circumferential protrusion 3.1.2 (i.e. due to the abutment) and then to the distal abutment structure 3.2 of the sleeve element 3 where preferably the first liquefication location respectively material flow occurs. The teeth 3.2.1 of the slider element 2 at least partially collapse due to the liquefaction and eventually connect to the second outer building layer 10.2 of the lightweight building panel 10 (i.e. depending on the structure and material of the latter). When the teeth 3.2.1 have collapsed respectively liquefied, the contact surface relative to the proximal surface 10.2.1 of the second outer building layer 10.2 is increased, such that the counter-load may be sufficient to force the slider element 2 down through the inner circumferential protrusion 3.1.2 of the sleeve element 3. This results in the liquefaction of material (second material flow) of usually both the slider element 2 (distal abutment structure 2.3) and the sleeve element 3 (inner circumferential protrusion 3.1.2) and thereby creating a vertical shear joint 4 at interface S between the sleeve element 3 and the slider element (i.e. when the material has re-solidified).

During the vertical downward movement of the slider element 2, the conical section 2.1.3 is pressed into the proximal flexible section 3.1.1 of sleeve element 3. Because of the afore-described geometrical dimensions, the wings 3.1.4 are elastically pushed away from the longitudinal axis X in the radial direction. This increases the initial inner radius d₁ of the proximal flexible section 3.1.1 to a maximum inner diameter d_{1′} (i.e. at the proximal end), such that the wings 3.1.4 radially expand beneath the distal surface 10.1.1 of the first outer building layer 10.1 which results in a clamping respectively frictional engagement. As a consequence, a vertical movement (e.g. pulling-out) of the connector assembly 1 out of the lightweight building panel 10 is prevented since the inner diameter of the expanded proximal flexible section (diameter d_{1′}) substantially corresponds to the diameter dₕ of the pre-shaped hole 11—which substantially corresponds to the outer diameter D1 of the head portion 2.1 in the region of the rim 2.1.2.

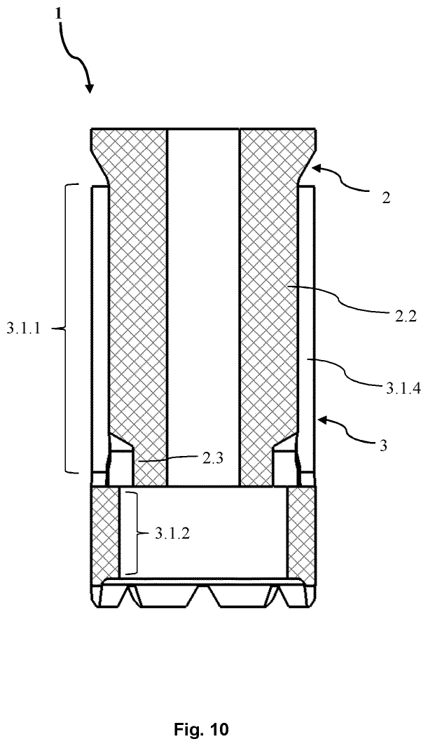

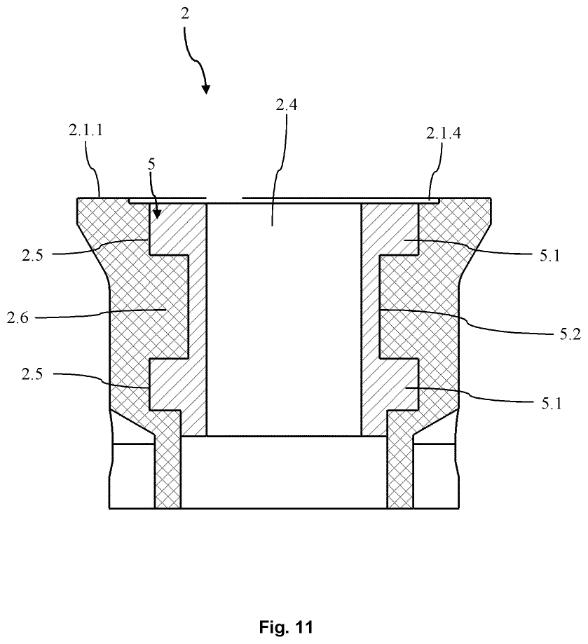

In FIG. 10 an elongated version of an inventive connector assembly 1 is illustrated. Therein, especially the proximal circumferential section 3.1.1 of the sleeve element 3 and the distal body portion 2.2 of the slider element 2 have a greater length than in the afore-described embodiment in order to be useable for correspondingly thicker lightweight building panels. Also, the length of the circumferential protrusion 3.1.2 is greater than in the afore-described embodiment whereas the distal abutment structure 2.3 of the slider element 2 (and thus of the resulting shear joint) remains substantially unchanged such that additional length may be gained In the embodiment of FIG. 11 a slider element is depicted the through opening 2.4 of which is formed by a metal insert 5. The metal insert 5 comprises, in this specific embodiment, two circumferential protrusions as first coupling means 5.1 and one circumferential recess formed therebetween as second coupling means 5.2 which are in positive engagement with corresponding circumferential recesses as first coupling means 2.5 of the slider element 2 and with a corresponding circumferential protrusion as second coupling means 2.6 of the slider element. In the proximal surface 2.1.1 of the head portion a circumferential recess 2.1.4 is formed, e.g. for receiving a corresponding mounting component.

This description and the accompanying drawings that illustrate aspects and embodiments of the present invention should not be taken as limiting-the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the figures individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

### LIST OF REFERENCE NUMERALS

1 connector assembly
2 slider element
2.1 head portion
2.1.1 proximal face
2.1.2 rim
2.1.3 conical/tapering section
2.1.4 circumferential recess
2.2 (distal) body portion
2.3 (distal) abutment structure
2.3′ after being liquefied
2.3.1 notch-like indentations
2.3.2 post-like elements
2.3.3 bottom face
2.3.2.1 longitudinal bulges
2.3.2.2 radial expansions
2.4 through opening
2.4.1 funnel-shaped insertion section
2.5 first coupling means
2.6 second coupling means
3 sleeve element
3.1 circumferential wall
3.1.1 proximal flexible section
3.1.2 inner abutment portion (inner circumferential protrusion)
3.1.2′ after being liquefied
3.1.2.1 front face (inner circumferential protrusion)/energy concentrator
3.1.2.2 upper face
3.1.3 longitudinal slots
3.1.4 wings
3.1.4.1 longitudinal slits
3.1.4.2 radial recess
3.2 abutment structure
3.3 proximal face
3.2.1 teeth
3.2.1.1 bevel/energy concentrator
3.2.2 gaps
4 shear joint
5 metal insert
5.1 first coupling means
5.2 second coupling means
10 lightweight building panel
10.1 first outer building layer
10.1.1 distal surface
10.1.2 proximal surface
10.2 second outer building layer
10.2.1 proximal surface
10.3 interlining layer
11 pre-shaped hole
12 hollow space
13 tee joint connection
20 sonotrode (schematically)
20.1 coupling-in face
d₁ inner diameter proximal flexible section
d_{1′} inner diameter expanded proximal flexible section
d₂ inner diameter inner abutment portion/inner circumferential protrusion
D₁ outer diameter head portion (proximal end)
D₂ outer diameter distal body portion
D_{2′} variable diameter distal body portion in the region of 2.3.1
D₃ diameter of the distal body portion (in the notch-like indentations)
D₄ diameter of through hole
dₕ inner diameter pre-shaped hole
A anchoring location
B anchoring location
N non-contact area
S interface/anchoring location
X longitudinal axis connector assembly

1. A connector assembly for being anchored in a lightweight building panel, the connector assembly comprising a slider element and a sleeve element wherein the sleeve element is configured to receive the slider element therein, wherein
the sleeve element comprises a circumferential wall having a proximal flexible section and an inner abutment portion,
the slider element comprises a head portion and a distal body portion, wherein
the head portion of the slider element being configured to radially expand the proximal flexible section of the sleeve element when the slider element is driven into the sleeve element during mounting, and
the distal body portion of the slider element and/or the inner abutment portion of the circumferential wall of the sleeve element being configured to allow relative movement after overcoming a resistance therebetween during mounting and to secure the distal body portion at the inner abutment portion, preferably by means of a shear joint being formed at an interface therebetween.

2. The connector assembly according to claim 1, wherein the head portion of the slider element comprises at its proximal end an outer diameter and the sleeve element comprises at its proximal end an inner diameter wherein the outer diameter of the proximal end of the head portion of the slider element is larger than the inner diameter of the proximal end of the sleeve element.

3. The connector assembly according to claim 1, wherein the head portion of the slider element tapers in the distal direction from the outer diameter at its proximal end to an outer diameter of the body portion wherein the outer diameter of the distal body portion substantially corresponds to the inner diameter of the sleeve element at its proximal end.

4. The connector assembly according to claim 1, wherein the taper of the head portion of the slider element comprises a substantially conical section.

5. The connector assembly according to claim 1, wherein the proximal flexible section of the circumferential wall of the sleeve element comprises two or more longitudinal slots wherein between two neighboring longitudinal slots a wing is formed, respectively.

6. The connector assembly according to claim 1, wherein the longitudinal slots of the circumferential wall of the sleeve element comprise an arc-shape, respectively.

7. The connector assembly according to claim 1, wherein the body portion of the slider element comprises at its distal outer circumference a plurality of notch-like indentations forming part of a distal abutment structure of the body portion of the slider element.

8. The connector assembly according to claim 1, wherein the plurality of notch-like indentations are evenly distributed about the distal outer circumference of the body portion of the slider element.

9. The connector assembly according to claim 1, wherein the notch-like indentations comprise an arc-shape.

10. The connector assembly according to claim 1, wherein between the notch-like indentations post-like elements are arranged which also form part of the abutment structure of the body portion of the slider element.

11. The connector assembly according to claim 1, wherein the post-like elements comprise longitudinal bulges at their outer wall.

12. The connector assembly according to claim 1, wherein the abutment structure of the body portion of the slider element being adapted to at least partially liquefy under application of mechanical vibrations and/or pressure.

13. The connector assembly according to claim 1, wherein the inner abutment portion of the sleeve element comprises an inner circumferential protrusion defining an inner diameter being smaller than the outer diameter of the abutment structure of the body portion, particularly in the region of the post-like elements in an unliquefied state.

14. The connector assembly according to claim 1, wherein the inner abutment portion of the sleeve element being adapted to at least partially liquefy under application of mechanical vibrations and/or pressure.

15. The connector assembly according to claim 1, wherein a variable diameter of the abutment structure of the body portion of the slider element in the region of the notch-like indentations is at least sectionally larger than the inner diameter defined by the inner abutment portion of the sleeve element.

16. The connector assembly according to claim 1, wherein the inner abutment portion is arranged in the longitudinal direction distally below the wings and longitudinal slots in the circumferential wall of the sleeve element.

17. The connector assembly according to claim 1, wherein the wings of the proximal flexible section of the sleeve element comprise at their inner walls longitudinal slits.

18. The connector assembly according to claim 1, wherein the distal abutment structure of the body portion of the slider element is adapted to form, in the liquefied state, a shear joint at an interface with the inner circumferential protrusion of the sleeve element.

19. The connector assembly according to claim 1, wherein the interface is formed between an inner front face of the inner circumferential protrusion of the sleeve element and an outer side wall portion of the liquefied abutment structure of the body portion of the slider element wherein the interface extends substantially parallel to the longitudinal axis of the connector assembly.

20. The connector assembly according to claim 1, wherein the sleeve element comprises at its distal end an abutment structure being adapted to at least partially liquefy under application of mechanical vibrations and/or pressure.

21. The connector assembly according to claim 1, wherein the abutment structure at the distal end of the sleeve element comprises a tooth-shaped configuration.

22. The connector assembly according to claim 1, wherein the tooth-shaped configuration includes teeth and gaps wherein preferably the circumferential length of the teeth is larger than the circumferential length of the gaps preferably the circumferential length of the teeth is between about 1.5 times and about 2.5 times of the circumferential length of the gaps and more preferably about 2 times of the circumferential length of the gaps.

23. The connector assembly according to claim 1, wherein the slider element comprises a central through opening

24. The connector assembly according to claim 1, wherein in the region of the head portion the through opening comprises a funnel-shaped insertion section

25. The connector assembly according to claim 1, wherein a sleeve-like metal insert is arranged in the through opening of the slider element.

26. The connector assembly according to claim 1, wherein the sleeve-like metal insert comprises first and second coupling means corresponding to first and second coupling means of the inner wall of the slider element.

27. The connector assembly according to claim 1, wherein the slider element being formed of a thermoplastic material wherein at least a portion of thermoplastic material is liquefiable.

28. The connector assembly according to claim 1 wherein the sleeve element being formed of a thermoplastic material wherein at least a portion of the thermoplastic material is liquefiable.

29. A method of anchoring a connector assembly in a lightweight building panel wherein the connector assembly comprises a slider element and a sleeve element wherein the sleeve element being configured to receive the slider element and wherein the lightweight building panel comprises at least a first outer building layer and an interlining layer, the method comprising the steps of:
providing the lightweight building panel with a pre-shaped hole for receiving the connector assembly;
introducing the sleeve element of the connector assembly into the pre-shaped hole of the lightweight building panel and bringing a distal abutment structure of a body portion of the slider element in contact with an inner abutment portion of the sleeve element, the distal abutment structure of the body portion of the slider element and/or the inner abutment portion of the sleeve element being adapted to liquefy under the application of mechanical vibrations and/or pressure;
coupling mechanical vibrations into a proximal face of a head portion of the slider element and/or exerting pressure thereon so as to cause energy absorption between the distal abutment structure of the body portion of the slider element and the inner abutment portion of the sleeve element and to at least partially liquefy the distal abutment structure of the body portion of the slider element and/or the inner abutment portion of the sleeve element thereby generating a material flow therebetween;
driving the slider element vertically downwards into the sleeve element
thereby expanding a proximal flexible section of the circumferential wall of the sleeve element by means of the head portion of the slider element wherein the proximal flexible section of the sleeve element engages with a distal surface of the first outer building layer of the lightweight building panel;
wherein the material flow enabling that the distal abutment structure of the body portion of the slider element overcomes and slides along the inner abutment portion of the sleeve element,
letting the material flow re-solidify whereby the distal abutment structure of the slider element is secured to the inner abutment portion of the sleeve element, preferably by forming a shear joint at an interface therebetween.

30. The method according claim 29, wherein the interface between the slider element and the sleeve element is substantially parallel to the longitudinal axis of the connector assembly.

31. The method according to claim 29, wherein the sleeve element is introduced into the pre-shaped hole until a distal end of the sleeve element which comprises a tooth-shaped abutment structure (3.2) is in contact with a proximal surface of a second outer building layer (10.2) of the lightweight building panel.

32. The method according to claim 29, wherein the tooth-shaped abutment structure at the distal end of the sleeve element is at least partially liquefied thereby generating material flow between the tooth-shaped abutment structure and the proximal surface of a second outer building layer so as to provide an enlarged contact area of the distal end of the sleeve and the proximal surface of the second outer building layer.

33. The method according to claim 29, wherein the enlarged contact area between the distal end of the sleeve and the proximal surface of the second outer building layer generates a counter load which supports the distal abutment structure of the body portion of the slider element getting past and sliding along the inner abutment portion of the sleeve element.

34. The method according to claim 29, wherein the material flow subsequently re-solidifies whereby the sleeve element is secured to the second outer building layer of the lightweight building panel, preferably means of a tee joint being formed therebetween.

35. The method according to claim 29, wherein the head portion of the slider element comprises at its proximal end an outer diameter and the sleeve element comprises at its proximal flexible section an inner diameter wherein the outer diameter of the proximal end of the head portion of the slider element is larger than the inner diameter of the proximal flexible section of the sleeve element so as to expand during mounting the inner diameter of the proximal flexible section sleeve element to an inner diameter being substantially as large as the inner diameter of the pre-shaped hole in the first outer building layer

36. The method according to claim 29, wherein the distal abutment structure of a body portion of the slider element comprises a plurality of notch-like indentations configured to provide for a pre-defined counter-load before partially liquefying and the slider element being driven vertically downwards into the sleeve element.

37. The method according to claim 29, wherein between the notch-like indentations post-like elements are formed comprising longitudinal bulges at their outer side wall being configured to prevent relative rotation between the slider element and the sleeve element.

38. The method according to claim 29, wherein the proximal flexible portion of the circumferential wall of the sleeve element comprises wings having longitudinal slits in their inner wall configured to prevent relative rotation between the slider element and the sleeve element.

39. The method according to claim 29, wherein the first outer building layer comprises a building layer material and is thinner and more dense than the interlining layer of the lightweight building panel.

40. The method according to claim 29, wherein the second outer building layer comprises a building layer material and is thinner and more dense than the interlining layer of the lightweight building panel.

41. The method according to claim 29, wherein the slider element being formed of a thermoplastic material wherein a portion of the thermoplastic material is liquefiable.

42. The method according to claim 29, wherein the sleeve element being formed of a thermoplastic material wherein a portion of the thermoplastic material is liquefiable.
